(19) United States
(12) Patent Application Publication
(10) Pub. No.: US 2007/0040796 A1
(43) Pub. Date: Feb. 22, 2007

(54) Liquid crystal display including a transflective polarizing filter and a method of providing power saving and security functions in the same

(75) Inventor: Kyung-hee Lee, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/450,374

(22) Filed: Jun. 12, 2006

(30) Foreign Application Priority Data
Aug. 16, 2005 (KR) 2005-74855

(51) Int. Cl. G09G 3/36

(52) U.S. Cl. 345/102

(57) ABSTRACT

An LCD including a transflective polarizing filter and a method of providing a power-saving function and a security-function in the LCD. The LCD includes an application module to receive a reflection ratio of a transflective polarizing filter which performs reflecting and polarizing operations, a reflection/polarization control module to control the reflection ratio of the transflective polarizing filter according to the reflection ratio, and a lamp driving module to generate a lamp driving voltage that corresponds to the reflection ratio to drive a lamp.

### CROSS-REFERENCE TO RELATED APPLICATIONS

This application claims priority from Korean Patent Application No. 2005-74855 filed on Aug. 16, 2005 in the Korean Intellectual Property Office, the disclosure of which is incorporated herein by reference in its entirety.

### BACKGROUND OF THE INVENTION

1. Field of the Invention

The present general inventive concept relates to power saving and security functions of a liquid crystal display (LCD), and more particularly, to a method of providing a power-saving function and a security function in an LCD by using a transflective polarizing filter.

2. Description of the Related Art

With recent development of new signal processing and display technologies, various displays that use liquid crystal have been developed.

Generally, LCDs are widely used in computers, electronic devices, information communication devices, etc., due to their low-power consumption, light weight, and small size. LCDs are also widely used in a display device or a display monitor of portable computers, desktop computers, high-quality video appliances, laptop computers, etc.

A liquid crystal panel having an LCD includes a plurality of pixels arranged in a matrix, each pixel having a thin-film transistor (TFT) panel, a common electrode display panel, and a liquid crystal layer interposed between the TFT and common electrode panels. If the voltage between the TFT panel and the common electrode display panel is varied, liquid crystal molecules in the liquid crystal layer are realigned to affect a pixel luminance. That is, a liquid crystal material having an anisotropic dielectric ratio is injected between the TFT panel and the common electrode display panel, and an electric field with a controlled intensity is applied to the liquid crystal material so that light transmitted through the TFT and common electrode panels is controlled to obtain desired images.

LCDs are generally classified as either a twisted nematic (TN) type or a super-twisted nematic (STN) type. Examples of LCDs include an active-matrix display that uses a switching element, a TN liquid crystal display, and a passive-matrix display of STN type.

The active-matrix display is used in TFT-LCDs driven by thin-film transistors (TFTs) as switching elements. On the other hand, the passive-matrix display does not use a transistor, thus no complicated circuits are required. Recently, the widespread use of portable computers has resulted in an increase in implementation of TFT-LCDs.

One important factor that determines the quality of portable computers that use an LCD display device is a duration of a life of a battery (i.e., a battery life span).

Korean Patent Unexamined Publication No. 2002-0003652 describes a power-saving apparatus and method of a laptop computer in which a user previously determines whether a multi-bay device (CD-ROM, DVD-ROM, FDD, etc.) is in use when a battery power source is applied to the laptop computer during a portable mode, so that power supplied to the multi-bay device can be selectively turned on/off to minimize power consumption of the laptop computer, thereby extending an amount of time that the laptop computer can operate in the portable mode.

However, when considering the fact that the power consumed by liquid crystal panels is about 40% of overall power consumed in laptop computers, the above-mentioned apparatus and method are inadequate in providing a suitable solution for reducing the power consumption of laptop computers.

Further, security functions for managing and protecting personal information have recently become more important to consumers. There is a need to protect personal information or information displayed on a screen of a laptop computer from being viewed by a third party during use, or when a user temporarily leaves the laptop computer. However, the above-mentioned apparatus and method do not provide any type of security feature.

Although a screen saver can be used to protect personal information, the screen saver is operated in such a manner that various red, green and blue values are scanned using software. This scanning consumes power, thereby making it difficult to minimize the power consumption of laptop computers when operating in the portable mode.

Therefore, a method of reducing the power consumed by liquid crystal panels in order to decrease the overall power consumption of LCDs, while simultaneously providing a security function to protect personal information or information displayed on the screen of the portable computer is desirable.

### SUMMARY OF THE INVENTION

Accordingly, the present general inventive concept provides a method of saving power and securing information in an LCD by controlling a reflection ratio of a transflective polarizing filter provided in the LCD, and controlling an intensity of light emitted to a liquid crystal panel.

Additional aspects of the present general inventive concept will be set forth in part in the description which follows and in part will become apparent to those having ordinary skill in the art upon examination of the following or may be learned from practice of the general inventive concept.

The foregoing and/or other aspects of the present general inventive concept are achieved by providing a liquid crystal display (LCD), including a liquid crystal panel to display information, a transflective polarizing filter disposed adjacent to the liquid crystal panel to reflect and polarize light, at least one lamp disposed adjacent to the liquid crystal panel to provide light thereto, an application module to receive an input of a reflection ratio of a transflective polarizing filter, a reflection/polarization control module to control the reflection ratio of the transflective polarizing filter according to the received reflection ratio, and a lamp driving module to generate a lamp driving voltage that corresponds to the received reflection ratio to drive the at least one lamp.

The foregoing and/or other aspects of the present general inventive concept are also achieved by providing an LCD, including a liquid crystal panel, a transflective polarizing filter formed on both sides of the liquid crystal panel to perform reflecting and polarizing operations according to a predetermined reflection ratio, a back light unit disposed adjacent to the liquid crystal panel and having at least one lamp to emit light using a lamp driving voltage and to transmit the emitted light to the liquid crystal panel, and a lamp driving module to provide the lamp driving voltage that corresponds to the predetermined reflection ratio to the at least one lamp.

The foregoing and/or other aspects of the present general inventive concept are also achieved by providing a liquid crystal display, including a liquid crystal panel having a plurality of pixels to display information, and a transflective filter disposed on at least one side of the liquid crystal panel to reflect almost all external light when operating in a security mode such that the displayed information is not visible.

The foregoing and/or other aspects of the present general inventive concept are also achieved by providing a liquid crystal display, including a liquid crystal panel to display information, a backlight unit having an adjustable intensity to provide internal light to the liquid crystal panel from a rear side thereof, and a transflective filter disposed on at least one surface of the liquid crystal panel and having an adjustable reflectance to reflect external light from a front side thereof.

The foregoing and/or other aspects of the present general inventive concept are also achieved by providing an LCD screen, including a liquid crystal panel, a transflective filter disposed on at least one surface of the liquid crystal panel and having a first reflectance when the LCD screen is in a first screen state and a second reflectance when the LCD screen is in a second screen state, and a backlight unit to provide light to the liquid crystal panel of a first intensity when the LCD screen is in the first screen state and to provide light to the liquid crystal panel of a second intensity when the LCD screen is in the second screen state.

The foregoing and/or other aspects of the present general inventive concept are also achieved by providing a user interface to control operation of an LCD screen having a transflective filter to reflect light, a lamp, and a driving module to drive the lamp, the interface including a reflection ratio set area to select a reflection ratio of the transflective filter such that a predetermined portion of external light is reflected by the transflective filter.

The foregoing and/or other aspects of the present general inventive concept are also achieved by providing a method of saving power and securing information in an LCD, the method including setting a reflection ratio of a transflective polarizing filter which performs reflecting and polarizing operations in the LCD, controlling the reflection ratio of the transflective polarizing filter according to the set reflection ratio, generating a lamp driving voltage that corresponds to the set reflection ratio while controlling the reflection ratio of the transflective polarizing filter, and driving a lamp in the LCD using the generated lamp driving voltage.

The foregoing and/or other aspects of the present general inventive concept are also achieved by providing a method of controlling a liquid crystal display having a liquid crystal panel, the method including controlling the liquid crystal panel to display information, and adjusting the amount of external light being reflected by the liquid crystal panel based on a mode in which the liquid crystal display is being operated.

The foregoing and/or other aspects of the present general inventive concept are also achieved by providing a method of controlling a liquid crystal display having a liquid crystal panel, a backlight unit, and a driving module to drive the backlight unit, the method including controlling the liquid crystal panel to display information, controlling a transflective filter disposed on a surface of the liquid crystal panel to reflect a predetermined portion of external light based on a mode of the LCD, and controlling the driving module to drive the backlight unit based on the predetermined portion of the external light that is reflected by the transflective filter.

### BRIEF DESCRIPTION OF THE DRAWINGS

The above aspects of the present general inventive concept will become more apparent from the following detailed description, taken in conjunction with the accompanying drawings, in which:

FIG. 1 is an exploded perspective view illustrating a liquid crystal display (LCD) according to an embodiment of the present general inventive concept;

FIG. 2 is a partial perspective view illustrating a partial region of a liquid crystal panel of the LCD of FIG. 1;

FIG. 3 is a block diagram illustrating a logic configuration of an LCD according to an embodiment of the present general inventive concept;

FIG. 4 is a flowchart illustrating a method of providing power-saving and security functions in an LCD according to an embodiment of the present general inventive concept; and

FIG. 5 is an exemplary view illustrating a user interface according to an embodiment of the present general inventive concept.

### DETAILED DESCRIPTION OF THE PREFERRED EMBODIMENTS

Hereinafter, embodiments of the present general inventive concept will be described in detail with reference to the accompanying drawings. The aspects and features of the present general inventive concept and methods of achieving the aspects and features will be apparent by referring to the embodiments to be described in detail with reference to the accompanying drawings. However, the present general inventive concept is not limited to the embodiments disclosed hereinafter, but can be implemented in various forms. The matters defined in the description, such as the detailed construction and elements are specific details provided in order to assist those of ordinary skill in the art in a comprehensive understanding of the general inventive concept. The present general inventive concept is defined by the appended claims. Throughout the entire description, the same reference numerals are used for the same or similar elements in various figures.

A liquid crystal display (LCD) according to an embodiment of the present general inventive concept includes a device that provides information to a user through a liquid crystal panel. Examples of devices that can be implemented with the LCD include a portable multimedia player (PMP), a personal digital assistant (PDA), a portable digital versatile disk (DVD) player, a cellular phone, a laptop computer, and a digital TV. Hereinafter, the LCD according to embodiments of the present general inventive concept will be described based on a display monitor for a computer. However, it should be understood that the present general inventive concept is not limited to this display monitor, and can be implemented in the above-mentioned examples of the LCD, or with other types of devices.

In general, an LCD can typically be classified as a vertical electric field type LCD or an in-plane switching (IPS) type LCD depending on a driving manner. Also, an LCD may be classified as an LCD having a thin-film transistor (TFT) formed on a first substrate disposed on a first side of a liquid crystal panel and a color filter formed on a second substrate disposed on a second side of the liquid crystal panel, or as a color filter on thin-film transistor (COT) type LCD having both the thin-film transistor and the color filter formed on the first substrate. Hereinafter, embodiments of the present general inventive concept will be described with respect to the vertical electric field type LCD having the thin-film transistor formed on the first substrate and the color filter formed on a second substrate. However, it should be understood that the present general inventive concept is not limited to the vertical electric field type LCD, and can include other LCDs such as the IPS type LCD having the thin-film transistor formed on the first substrate and the color filter formed on the second substrate, the IPS type LCD having both the thin-film transistor and the color filter formed on the second substrate, and a COT type vertical electric field LCD having both the thin-film transistor and the color filter formed on the second substrate.

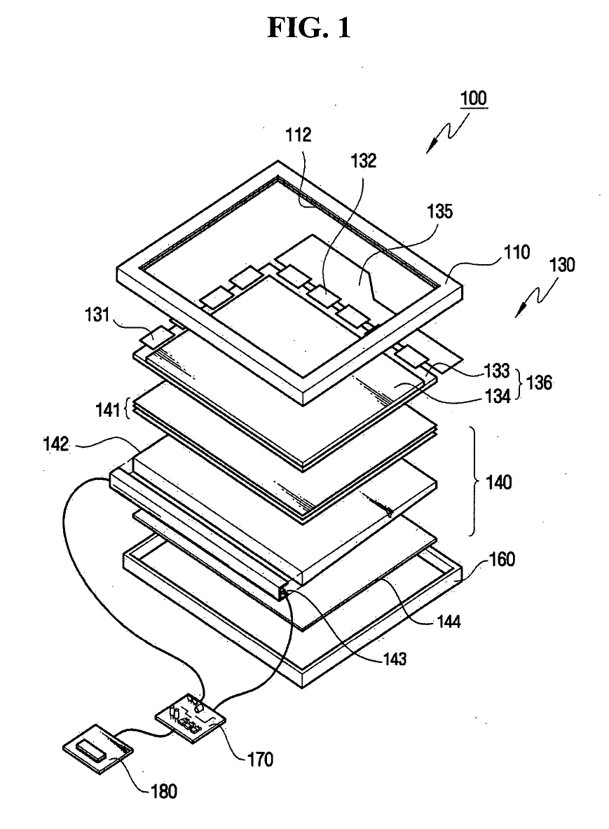

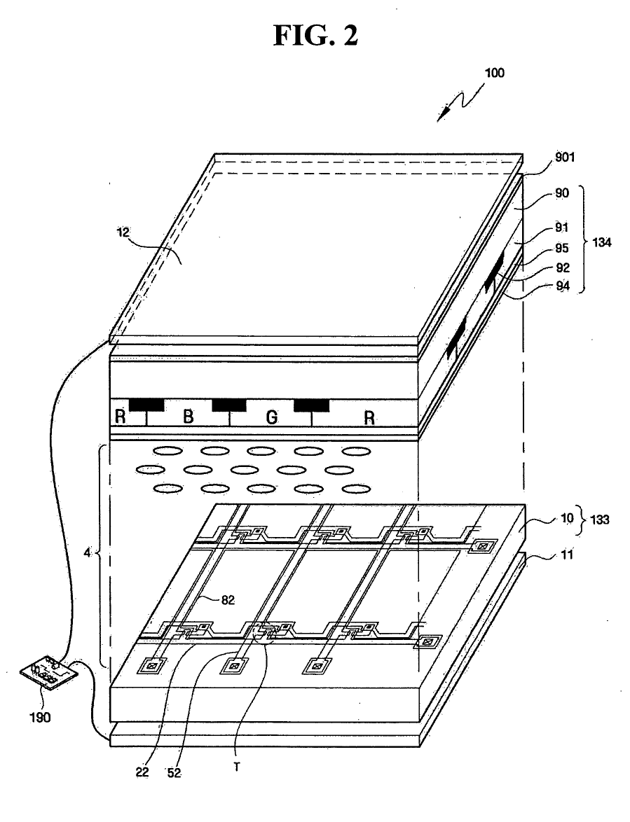

FIG. 1 is an exploded perspective view illustrating a liquid crystal display (LCD) 100 according to an embodiment of the present general inventive concept, and FIG. 2 is a partial perspective view illustrating a partial region of a liquid crystal panel 136 of the LCD 100 of FIG. 1. Referring to FIGS. 1 and 2, the LCD 100 includes a liquid crystal panel assembly 130, a back light unit 140, an upper case 110, and a lower case 160.

The liquid crystal panel assembly 130 includes a liquid crystal panel 136 formed, for example, by injecting a liquid crystal material (e.g., in a liquid crystal layer 4) having an anisotropic dielectric property between a first substrate (e.g., a first insulating layer 10 and/or a thin film transistor (TFT) display panel 133) and a second substrate (e.g., a second insulating layer 90 and/or a common electrode display panel 134), a driving integrated circuit (IC) electrically connected to the liquid crystal panel 136, for example, by a chip on glass (COG) manner or a tape-automated bonding (TAB) manner to respectively apply a driving signal to gate and data lines 22 and 52 formed on the liquid crystal panel 136, and a printed circuit board 135 to transmit predetermined data and a control signal to the driving IC.

The liquid crystal panel assembly 130 is fixed to the back light unit 140. The liquid crystal panel assembly 130 and the back light unit 140 are disposed between the lower case 160 and the upper case 110.

The liquid crystal panel assembly 130 includes the liquid crystal panel 136, a gate-tape carrier package 131, a data-tape carrier package 132, and the printed circuit board 135.

The liquid crystal panel 136 includes the TFT display panel 133, the common electrode display panel 134 arranged to face the TFT display panel 133, and the liquid crystal layer 4 interposed between the TFT display panel 133 and the common electrode display panel 134 and being aligned in a predetermined direction. The TFT display panel 133 is provided with the gate lines 22, the data lines 52, a thin-film transistor (T) array, and pixel electrodes 82 sequentially formed on the first insulating substrate 10.

The common electrode display panel 134 will be described in more detail with reference to FIG. 2. The common electrode display panel 134 is provided with a black matrix 92, a color filter 91, an overcoating layer 95, and a common electrode 94 sequentially formed on a first surface of the second insulating substrate 90.

The black matrix 92 is formed of an opaque material. An opening (not shown) is formed at a part of the black matrix 92 to transmit light from the thin-film transistor display panel 133 to an upper portion of the common electrode display panel 134. The opening is generally formed on a region that corresponds to a pixel of the TFT display panel 133. For example, if the pixel is formed in a square shape, the opening of the black matrix 92 may also be formed in a square shape to correspond to the pixel. In another example, if the pixel is formed in a bent-belt shape, the opening of the black matrix 92 may also be formed in a bent-belt shape to correspond to the pixel.

A color filter 91 is formed on the black matrix 92 and includes red, green, and blue sub color filters. The red, green, and blue sub-color filters form one unit pixel.

The overcoating layer 95 is formed on the color filter 91. Here, the overcoating layer 95 serves to planarize the color filter 91 and improves adhesion with the common electrode 94, which will be described later. The overcoating layer 95 is formed of a transparent material, and may selectively be formed.

The common electrode 94 is formed on the overcoating layer 95 and generates a potential difference from the pixel electrode 82 of the TFT display panel 133 to apply an electric field to the liquid crystal layer 4. The common electrode 94 may be formed of a transparent conductive material such as indium tin oxide (ITO) or indium zinc oxide (IZO).

A scattering layer 901 is formed on a second surface of the second insulating substrate 90. The scattering layer 901 scatters light reflected from a surface of the liquid crystal panel 136 so as to reduce glare generated from the reflected light. The second surface of the second insulating substrate 90 may be polished using a predetermined polish.

Furthermore, a lower polarizing filter 11 and an upper polarizing filter 12 (i.e., a transflective polarizing filter) are provided below and above the liquid crystal panel 136, respectively, to transmit light that is parallel to a polarization axis. The upper polarizing filter 12 and the lower polarizing filter 11 are respectively bonded to both surfaces of the liquid crystal panel 136 so that their respective polarization axes are within a range of 90° with respect to each other. Transflective polarizing filters that perform reflecting and polarizing functions may be used as the polarizing filters.

The upper polarizing filter 12 and the lower polarizing filter 11 are respectively connected to reflection/polarization control chips 190 that control the polarizing filters 11 and 12.

The reflection/polarization control chips 190 control reflection ratios of the upper polarizing filter 12 and the lower polarizing filter 11 to correspond to a setting value input by a user or preset before operation. A “reflection ratio” refers to a range in which external light (i.e., light that is incident on the LCD panel assembly 130 from a side at which the upper case 110 is positioned) is reflected from the upper polarizing filter 12 when the user views the liquid crystal panel assembly 130. Therefore, if the reflection ratio is in a range close to 0%, the upper polarizing filter 12 does not reflect any externally input light. Accordingly, an appearance of the user viewing the liquid crystal display panel assembly 130 (i.e., a user's reflection) is not displayed in the liquid crystal panel 136. Similarly, if the reflection ratio is in a range of 100%, all external light is reflected from the upper polarizing filter 12. In this case, all displayed information generated by the pixels in the LCD 100 visually disappears, and the upper polarizing filter 12 functions as a mirror.

The gate-tape carrier package 131 is connected to each gate line 22 formed on the TFT display panel 133, and the data-tape carrier package 132 is connected to each data line 52 formed on the TFT display panel 133.

Various driving parts are provided on the printed circuit board 135 to process gate and data driving signals so that the gate driving signal is input to the gate-tape carrier package 131 and the data driving signal is input to the data-tape carrier package 132.

When the reflection/polarization control chips 190 function as graphic control chips, the reflection/polarization control chips 190 control the upper polarizing filter 12 and the lower polarizing filter 11, as described above, and provide control and data signals to the printed circuit board 135 to drive the liquid crystal panel 136.

The back light unit 140 includes optical sheets 141 disposed adjacent to the liquid crystal panel 136, a light-guide plate 142 disposed adjacent to the optical sheets 141, a lamp assembly 143 disposed at one or more sides of the light guide plate 142, and a reflecting plate 144 disposed between the lower case 160 and the light guide plate 142.

The light-guide plate 142 guides light transmitted by the lamp assembly 143 to the liquid crystal panel assembly 130. The light-guide plate 142 may be formed of a transparent plastic material, such as acryl to guide light emitted from the lamp assembly 143 toward the liquid crystal panel 136 mounted on the light-guide plate 142. Various patterns are printed on a rear surface of the light-guide plate 142 to change the direction of light entering the light-guide plate 142 to be transmitted to the liquid crystal panel 136 (i.e., upward in FIG. 1).

The lamp assembly 143 can include a lamp disposed at the side of the light-guide plate 142 to emit light and a lamp-reflecting plate surrounding the lamp.

The reflecting plate 144 is provided on a lower surface of the light-guide plate 142 to reflect light entering the lower surface of the light-guide plate 142 to an upper portion thereof. The reflecting plate 144 reflects light that is not reflected upward by a fine dot pattern on the rear surface of the light-guide plate 142 to an emitting surface of the light-guide plate 142 (i.e., the upper portion of the guide plate 142) so as to reduce a loss of light entering the liquid crystal panel 136, and to improve a uniformity of light transmitted to the emitting surface of the light-guide plate 142.

The optical sheets 141 are provided on an upper surface (i.e., the light emitting surface) of the light-guide plate 142 to diffuse and uniformly concentrate the light transmitted from the light-guide plate 142 to the liquid crystal panel 136. The optical sheets 141 may include a diffusion sheet, a prism sheet, and a protective sheet. The diffusion sheet is disposed between the light-guide plate 142 and the prism sheet to disperse the light from the light-guide plate 142 in order to prevent the light from being partially concentrated. The prism sheet is formed on an upper surface (i.e., the emitting surface) of the light-guide plate 142 in a predetermined arrangement of triangular prism sheets. Generally, the prism sheet may include two triangular prism sheets so that the respective prism sheets are alternately arranged to uniformly concentrate the light diffused from the diffusion sheet in a vertical direction to the liquid crystal panel 136. Therefore, the light that has passed through the prism sheet is substantially transmitted in the vertical direction, so that luminance distribution on the protective sheet is uniform. The protective sheet formed on the prism sheet protects the surface of the prism sheet and uniformly diffuses the light entering the light-guide plate 142.

Although the LCD 100 of the present embodiment is provided with one lamp formed at the side of the light-guide plate 142, the lamp assembly 143 may include a plurality of lamps to provide more luminance. For example, when the LCD 100 is a larger LCD 100, the plurality of lamps may effectively illuminate the liquid crystal panel 136. An inverter 170 is electrically connected to the lamp assembly 143 through a wire to apply power to the lamp of the lamp assembly 143.

The inverter 170 may be connected to a power control chip 180 that controls the inverter 170. The power control chip 180 controls the inverter 170 in conjunction with operation of the reflection/polarization control chips 190 that control the reflection ratios of the upper polarizing filter 12 and the lower polarizing filter 11, so as to control the power supplied to the lamp. In this case, the inverter 170 and the power control chip 180 may be provided in a single printed circuit board or a single chip to generate a voltage to drive the lamp.

The liquid crystal panel assembly 130 is provided on the protective sheet of the optical sheets 141, and is mounted in the lower case 160 along with the back light unit 140. The lower case 160 has a rectangular shape and is provided with a sidewall formed along an edge of an upper surface so that the back light unit 140 and the liquid crystal panel assembly 130 are received in the sidewall to fix the back light unit 140 and the liquid crystal panel assembly 130. Also, the lower case 160 prevents the back light unit 140, which includes a plurality of sheets, from being bent. The printed circuit board 135 of the liquid crystal panel assembly 130 is bent along an outer surface of the lower case 160 so that the printed circuit board 135 can be mounted on a rear surface of the lower case 160. In this case, the lower case 160 may have various shapes depending on a manner in which the back light unit 140 and/or the liquid crystal panel assembly 130 are received therein.

The upper case 110 and the lower case 160 are arranged to be coupled to each other to cover an upper surface of the liquid crystal panel assembly 130 disposed in the lower case 160. A window 112 is formed on an upper surface of the upper case 110 to externally expose the liquid crystal panel assembly 130.

The upper case 110 may be fixed to the lower case 160 using, for example, a hook (not shown). The hook may be formed along the outer surface of the sidewall of the lower case 160, and a hook insertion hole (not shown) may be formed at a side of the upper case 110 to receive the hook. Accordingly, the hook formed on the lower case 160 may be inserted into the hook insertion hole of the upper case 110 to secure the lower case 160 to the upper case 110. Alternatively, the upper case 110 may be secured to the lower case 160 using a variety of other mechanisms.

In the present embodiment, although the back light unit 140 includes the lamp assembly at one side of the light-guide plate 142, it should be understood that a flat type back light unit having a lamp assembly at both sides of a light-guide plate having a flat plane may be applied to the present general inventive concept.

Furthermore, although the back light unit 140 is shown and described as an edge type back light unit having the lamp at the side of the light-guide plate 142, it should be understood that a direct type back light unit having a plurality of lamps arranged on a base thereof without a light-guide plate may also be applied to the present general inventive concept.

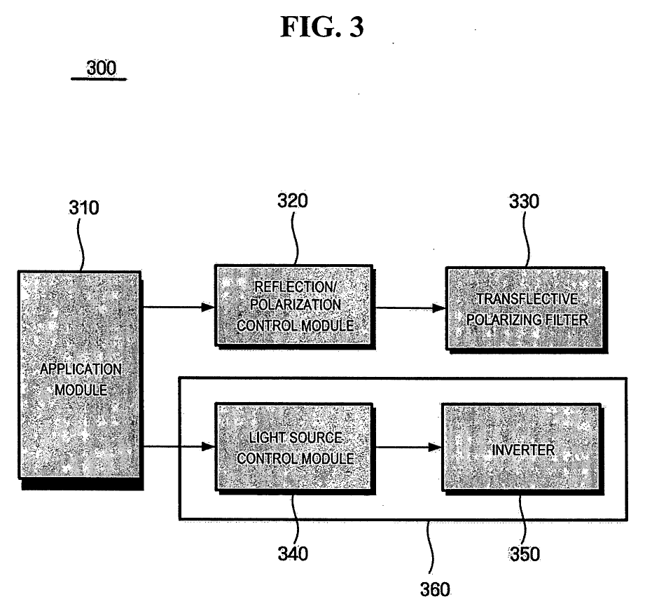

FIG. 3 is a block diagram illustrating a logic configuration of an LCD 300 according to an embodiment of the present general inventive concept. The LCD 300 of FIG. 3 may be similar to the LCD 100 of FIGS. 1 and 2. Accordingly, for illustration purposes, the block diagram of FIG. 3 will be described with reference to FIGS. 1 and 2.

Referring to FIG. 3, the LCD 300 includes an application module 310, a reflection/polarization control module 320, a transflective polarizing filter 330, and a lamp driving module 360.

The application module 310 provides an interface to enable a user to set the reflection ratio of the transflective polarizing filter 330, which may correspond to the upper and lower polarizing filters 11 and 12 of the LCD 100 of FIG. 2. The application module 310 also provides a first control signal and a second control signal. The first control signal controls the transflective polarizing filter 330 at the set reflection ratio while the second control signal controls a voltage input to the lamp of the back light unit 140 (see FIG. 1) to correspond to the first control signal and the set reflection ratio.

The reflection/polarization control module 320 is supplied with the first control signal from the application module 310 to control the reflection ratio of the transflective polarizing filter 330. The reflection/polarization control module 320 can control the reflection ratio of the transflective polarizing filter 330 using a phase difference of a pulse width modulation (PWM) signal. Also, the reflection/polarization control module 320 may use a graphic control chip.

The lamp driving module 360 generates a lamp driving voltage that corresponds to the set reflection ratio through the application module 310 so as to drive the lamp. As illustrated in FIG. 3, the lamp driving module 360 includes a light source control module 340 (e.g., the power control chip 180 of FIG. 1) and an inverter 350 (e.g., the inverter 170 of FIG. 1). The light source control module 340 may be a power control module.

The light source control module 340 is supplied with the second control signal from the application module 310 to provide the inverter 350 with a command to generate a voltage required to drive the lamp. The light source control module 340 may use a micro-controller.

The inverter 350 generates the voltage according to the command to drive the lamp. The inverter 350 can control the voltage supplied to the lamp using the phase difference of the PWM signal.

The reflection ratio of the transflective polarizing filter 330 has a direct relationship with the voltage supplied by the inverter 350 to the lamp. That is, the application module 310 controls the light source control module 340 (i.e., the power control module) to correspond to the reflection ratio, which may be set by the user.

For example, if the reflection ratio is in the range close to 0%, the upper polarizing filter 12 (see FIG. 2) does not reflect external light. At this time, the light source control module 340 controls the inverter 350 to obtain a maximum light intensity of the lamp so that the user can view various types of information displayed on the liquid crystal panel 136 (see FIG. 1) via the pixels of the LCD 300 (or 100).

Further, if the reflection ratio is in the range close to 100%, since all external light is reflected from the upper polarizing filter 12 (see FIG. 2), various types of information displayed on the liquid crystal panel 136 via the pixels of the LCD 300 (or 100) are not visible. In this case, the light source control module 340 controls the inverter 350 to stop driving the lamp, so that the power consumed by the lamp is reduced. As a result, it is possible to reduce the overall power consumed by the LCD 300 (or the LCD 100 of FIGS. 1 and 2). In addition, various types of information displayed on the liquid crystal panel 136 (see FIG. 1) via the pixels can be protected from being viewed by a third party by reflecting close to 100% of the external light from the upper polarizing filter 12 and/or not driving the lamp.

Further, if the reflection ratio is in a range between 0% to 100% (i.e., an intermediate range), the light source control module 340 controls the inverter 350 to generate the lamp driving voltage that corresponds to the reflection ratio. If the reflection ratio is increased, the corresponding lamp driving voltage is decreased. Since the information displayed by the liquid crystal panel 136 is less visible as the reflection ratio is increased, operation of the lamp has less of an effect on the visibility of the information on the liquid crystal panel 136. A linear or non-linear relationship may be provided between the reflection ratio and the lamp driving voltage. The lamp driving voltage that corresponds to the reflection ratio may be provided in a look-up table type database. The look-up table type database may store a plurality of lamp driving voltages and corresponding reflection ratios.

Therefore, it is possible to minimize the power consumption of the LCD 300 (or the LCD 100 of FIGS. 1 and 2) by controlling the reflection ratio of the polarizing filter 12 to prevent the information displayed on the liquid crystal panel 136 (see FIG. 1) from being viewed by a third party.

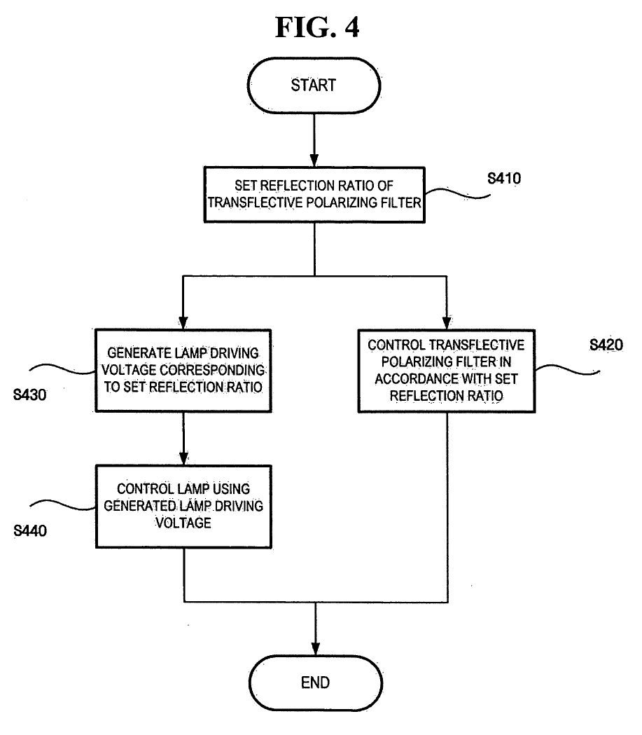

FIG. 4 is a flowchart illustrating a method of providing a power saving function and a security function in an LCD according to an embodiment of the present general inventive concept. The method may be performed in the LCD 100 of FIGS. 1 and 2, and/or the method may be performed in the LCD 300 of FIG. 3. Accordingly, for illustration purposes, the method of FIG. 4 is described below with reference to FIGS. 1 to 4.

First, the reflection ratio of the transflective polarizing filter 330 is set through a user interface provided on a screen of the LCD 300 (or the LCD 100 of FIGS. 1 and 2) in operation S410. The reflection ratio may be set by a user. Alternatively, the reflection ratio may be set according to one or more environmental or operational variables.

Then, the LCD 300 (or 100) controls the transflective polarizing filter 330 in accordance with the set reflection ratio in operation S420 and at the same time generates a lamp driving voltage that corresponds to the set reflection ratio in operation S430. At this time, a predetermined operation equation is used to determine the lamp driving voltage in accordance with the set reflection ratio, or the lamp driving voltage is determined in accordance with the look-up table. Then, the lamp is controlled by the generated lamp driving voltage to emit light in operation S440.

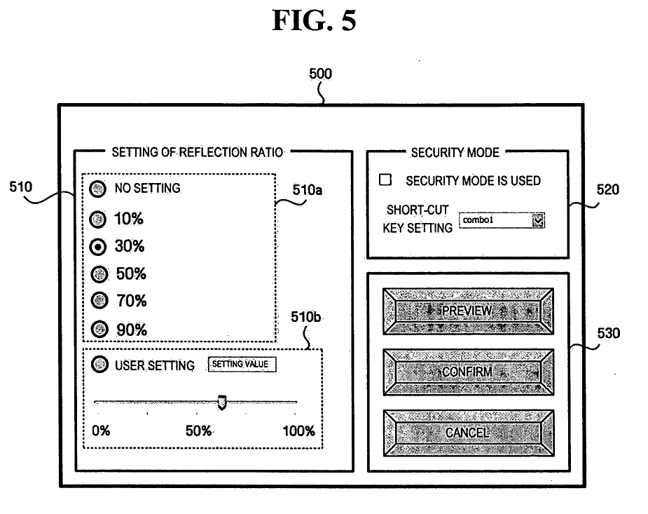

The application module 310 illustrated in FIG. 3 can provide the user with the user interface to enable the user to control the reflection ratio of the transflective polarizing filter 330 as illustrated in FIG. 5.

FIG. 5 is an exemplary view illustrating a user interface 500 according to an embodiment of the present general inventive concept. Referring to FIG. 5, the user interface 500 includes a reflection-ratio set area 510, a security-mode set area 520, and an executing area 530.

The reflection ratio set area 510 includes a selection area 510A and an input area 510B. The selection area 510A allows the user to select a reflection ratio from a plurality of preset reflection ratios, and the input area 510B allows the user to directly input a desired reflection ratio.

If the user selects the reflection ratio from the selection area 510A, the lamp driving voltage that corresponds to the selected reflection ratio can be determined using the look-up table and can then be output to the lamp. If the user inputs the reflection ratio using the input area 510B, the lamp driving voltage that corresponds to the input reflection ratio input can be determined by using the predetermined operation equation and can then be output to the lamp.

The security-mode set area 520 can be used if the user uses the liquid crystal panel as a mirror function. In this case, no voltage is supplied to the lamp. The mirror function may be invoked to control the transflective polarizing filter 330 to operate as a mirror such that none of the displayed information can be viewed. For example, the mirror function can be set to operate based on a command, or may be set on a timer.

Furthermore, when the user intends to release the security mode, the user can set a short-cut key among combination menus to return to an original screen state using the set short-cut key, thereby enhancing security.

The executing area 530 may include a preview button, a confirm button, and a cancel button. The preview button allows the user to preview a screen state of the LCD 300 (or 100) depending on the set reflection ratio. The confirm button controls the transflective polarizing filter 330 and the lamp driving voltage in accordance with the reflection ratio set by the user. The cancel button allows the user to cancel the current reflection ratio to return to a previous screen state. Accordingly, the user can select a desired screen state based on viewing preferences and/or power requirements. Although FIG. 5 has particular screen and menu arrangements, it should be understood by one of ordinary skill in the art that the arrangement of FIG. 5 is merely exemplary and that other arrangements may alternatively be used without departing from the scope of the present general inventive concept.

The present general inventive concept may be embodied as executable code in computer readable media including storage media such as magnetic storage media (ROMs, RAMs, floppy disks, magnetic tapes, etc.), optically readable media (CD-ROMs, DVDs, etc.), and carrier waves (transmission over the Internet). For example, the computer readable media may contain the application module 310 and/or the reflection/polarization control module 320.

As described above, in the various embodiments of the present general inventive concept, a reflection ratio of a transflective polarizing filter provided in an LCD and an intensity of light are controlled together to simultaneously provide a power-saving function and a security function in the LCD. In addition, it is possible to provide a mirror function through a liquid crystal panel of the LCD.

Although a few embodiments of the present general inventive concept have been described for illustrative purposes, those skilled in the art will appreciate that various modifications, additions and substitutions are possible, without departing from the scope and spirit of the general inventive concept as disclosed in the accompanying claims.

What is claimed is:

1. An LCD comprising:
a liquid crystal panel to display information;
a transflective polarizing filter disposed adjacent to the liquid crystal panel to reflect and polarize light;
at least one lamp disposed adjacent to the liquid crystal panel to provide light thereto;
an application module to receive an input of a reflection ratio for the transflective polarizing filter;
a reflection/polarization control module to control the reflection ratio of the transflective polarizing filter according to the received reflection ratio; and
a lamp driving module to generate a lamp driving voltage that corresponds to the reflection ratio to drive the at least one lamp.

2. The LCD as claimed in claim 1, wherein the reflection/polarization control module controls the reflection ratio of the transflective polarizing filter using a phase difference of a PWM signal.

3. The LCD as claimed in claim 1, wherein the lamp driving module generates the lamp driving voltage using a phase difference of a PWM signal.

4. The LCD as claimed in claim 1, wherein the reflection ratio has a predetermined relationship with the lamp driving voltage.

5. The LCD as claimed in claim 1, wherein the transflective polarizing filter operates as a mirror for a predetermined value of the received reflection ratio.

6. The LCD as claimed in claim 1, wherein the application module provides a user interface that enables a user to input the reflection ratio.

7. An LCD comprising:
a liquid crystal panel;
a transflective polarizing filter formed on both sides of the liquid crystal panel to perform reflecting and polarizing operations according to a predetermined reflection ratio;
a back light unit disposed adjacent to the liquid crystal panel and having at least one lamp to generate light using a lamp driving voltage and to transmit the generated light to the liquid crystal panel; and
a lamp driving module to provide the lamp driving voltage that corresponds to the predetermined reflection ratio to the at least one lamp.

8. A liquid crystal display, comprising:
a liquid crystal panel having a plurality of pixels to display information; and
a transflective filter disposed on at least one side of the liquid crystal panel to reflect almost all external light when operating in a security mode such that the displayed information is not visible.

9. The LCD as claimed in claim 8, wherein in the security mode, the transflective filter operates as a mirror such that a reflection is produced.

10. The LCD as claimed in claim 8, further comprising:
a backlight unit to provide light to the liquid crystal panel from a rear side thereof; and
a driving unit to drive the backlight unit with a predetermined driving signal when the transflective filter operates in a normal mode, and the driving unit does not drive the backlight unit with the predetermined driving signal when the transflective filter operates in the security mode.

11. The LCD as claimed in claim 8, wherein the transflective filter is switchable from the security mode to a normal mode by inputting a predetermined combination of keys.

12. The LCD as claimed in claim 8, further comprising:
a thin film transistor substrate disposed on one side of the liquid crystal panel.

13. A liquid crystal display, comprising:
a liquid crystal panel to display information;
a backlight unit having an adjustable intensity to provide internal light to the liquid crystal panel from a rear side thereof; and
a transflective filter disposed on at least one surface of the liquid crystal panel and having an adjustable reflectance to reflect external light from a front side thereof.

14. The LCD as claimed in claim 13, further comprising:
a driving module to select one of a plurality of driving voltages to drive the backlight unit based on a current reflectance of the transflective filter.

15. The LCD as claimed in claim 13, wherein the transflective filter comprises first and second polarizing filters to transmit light that is parallel to a polarization axis and being respectively bonded to opposite surfaces of the liquid crystal panel such that respective polarization axes are within a range of 90° with respect to each other.

16. The LCD as claimed in claim 13, further comprising:
a reflection polarization control chip to control the transflective filter to adjust a current reflectance thereof according to a predetermined reflection ratio.

17. An LCD screen, comprising:
a liquid crystal panel;
a transflective filter disposed on at least one surface of the liquid crystal panel and having a first reflectance when the LCD screen is in a first screen state and a second reflectance when the LCD screen is in a second screen state; and
a backlight unit to provide light to the liquid crystal panel of a first intensity when the LCD screen is in the first screen state and to provide light to the liquid crystal panel of a second intensity when the LCD screen is in the second screen state.

18. A user interface to control operation of an LCD screen having a transflective filter to reflect light, a lamp, and a driving module to drive the lamp, the interface comprising:
a reflection ratio set area to select a reflection ratio of the transflective filter such that a predetermined portion of external light is reflected by the transflective filter.

19. The interface as claimed in claim 18, further comprising:
an executing area to enable the selected reflection ratio to be previewed as it would appear on the LCD screen, to enable the selected reflection ratio to be confirmed, and to enable the selected reflection ratio to be canceled.

20. The interface as claimed in claim 18, further comprising:
a security mode set area to set a security mode operability in which the transflective filter reflects a majority of the external light such that information displayed on the LCD screen is not visible.

21. The interface as claimed in claim 18, wherein the driving module selects a driving voltage that corresponds to the selected reflection ratio to drive the lamp.

22. The interface as claimed in claim 18, wherein the reflection ratio set area comprises:
a first set area in which one of a predetermined plurality of reflection ratios are selectable as the selected reflection ratio; and
a second set area in which the selected reflection ration can be given any ratio value.

23. A method of saving power and securing information in an LCD, the method comprising:
setting a reflection ratio of a transflective polarizing filter that provides reflecting and polarizing operations in the LCD;
controlling the reflection ratio of the transflective polarizing filter according to the set reflection ratio;
generating a lamp driving voltage that corresponds to the set reflection ratio while controlling the reflection ratio of the transflective polarizing filter; and
driving a lamp using the generated lamp driving voltage.

24. The method as claimed in claim 23, wherein the controlling of the reflection ratio comprises controlling the reflection ratio using a phase difference of a PWM signal.

25. The method as claimed in claim 23, wherein the generating of the lamp driving voltage comprises generating the lamp driving voltage using a phase difference of a PWM signal.

26. The method as claimed in claim 23, wherein the reflection ratio has a predetermined relationship with the lamp driving voltage.

27. The method as claimed in claim 23, wherein the controlling of the reflection ratio comprises controlling of the transflective polarizing filter to operate as a mirror when the set reflection ratio has a predetermined value.

28. The method as claimed in claim 23, further comprising:
providing a user interface to enable a user to input the reflection ratio.

29. A method of controlling a liquid crystal display having a liquid crystal panel, the method comprising:
controlling the liquid crystal panel to display information; and
adjusting the amount of external light being reflected by the liquid crystal panel based on a mode in which the liquid crystal display is being operated.

30. The method as claimed in claim 29, wherein when the liquid crystal display operates in a security mode almost all the external light is reflected from the liquid crystal panel such that the displayed information is not visible.

31. A method of controlling a liquid crystal display having a liquid crystal panel, a backlight unit, and a driving module to drive the backlight unit, the method comprising:
controlling the liquid crystal panel to display information;
controlling a transflective filter disposed on a surface of the liquid crystal panel to reflect a predetermined portion of external light based on a mode of the LCD; and
controlling the driving module to drive the backlight unit based on the predetermined portion of the external light that is reflected by the transflective filter.

32. The method as claimed in claim 31, wherein the controlling of the driving module comprises selecting one of a plurality of driving voltages according to the predetermined portion of reflected external light and applying the selected driving voltage to the backlight unit.
